(19) United States
(12) Patent Application Publication
(10) Pub. No.: US 2009/0194303 A1
(43) Pub. Date: Aug. 6, 2009

(54) Height and Gradient adjustment system

(76) Inventor: Ralph P. Moe, Seabrook, TX (US)

Correspondence Address: John Sparks, 3602 Burke Rd. # 171, Pasadena, TX, 77504, US

(21) Appl. No.: 12/384,164

(22) Filed: Apr. 1, 2009

Related U.S. Application Data
(62) Division of application No. 11/451,760, filed on Jun. 13, 2006.

(51) Int. Cl. E02F 3/76; A01B 15/14; A01B 76/00

(52) U.S. Cl. 172/799.5; 172/776

(57) ABSTRACT

A height and gradient adjustment system is disclosed for raising, lowering, leveling, and changing a gradient, especially the gradient of implements. The height and gradient adjustment system enables independent height adjustment of each side, right or left, of the implement.

### CROSS-REFERENCE TO RELATED APPLICATIONS:

This is a division of U.S. patent application Ser. No. 11/451,760, filed Jun. 13, 2006, by the inventor, Ralph P. Moe. Applicant incorporates by reference the information and contents of U.S. patent application Ser. No. 11/451,760, filed Jun. 13, 2006. Applicant claims the benefit of the filing date of U.S. patent application Ser. No. 11/451,760, filed Jun. 13, 2006.

### FIELD OF INVENTION

The embodiments of this invention relates to a height and gradient adjustment system for raising, lowering, leveling, and changing a gradient, including the gradient of implements.

### BACKGROUND OF THE INVENTION

Graders are implements used to move dirt, sand, soil, and rock. While other implements can move soil components, graders spread the soil components smoothly leaving a contoured appearance to the landscape. This contoured appearance is both desirable and required by certain endeavors.

Graders are used by road maintenance personnel, construction personnel, some farmers, large landscapers, and anyone desiring to move soil components and leave the premises in a relatively smooth condition once the task is finished. Each different consumer may have very different needs to be met by a grader.

Many different implements can be used to loosen hardened soil so it can be processed. Most of these involve the use of claws, forks, plows, prongs, or points. Most of this equipment is expensive and heavy.

For properly working the soil into the desired condition, a system for raising, lowering, and adjusting the inclination or gradient of the implement is desirable. The inclination of the implement affects how the soil is processed and the gradient that the soil has once it is processed. Many implements work better and process the soil better when the operator can make adjustments to the gradient of the implement.

There are also different systems for raising, lowering, leveling, and adjusting the inclination of implements. Many of these systems use turn screws or spacers in conjunction with hydraulic cylinders or power jacks to attain small changes in gradient. The applicant designed his implement for attaining large differences in gradient.

While there may be many different graders, road maintenance, and soil maintenance implements available, the inventor could not find an implement to meet his needs. What was needed was an implement that was capable of performing road maintenance and soil grading that was lightweight, easily transported on roads, easily transformed from a working position to a transportable position, and vice versa, durable for doing difficult work, simple in design and operation, easy to use, inexpensive, safe, could be operated by one person, could easily break up hardened soil, could be pulled by a pickup truck, 4WD truck, sport utility vehicle, or tractor, and having a strong multipositional blade.

The implement, disclosed herein, has several desirable capabilities that other implements do not have. The disclosed implement has several adjustments that can be made to improve performance of the implement. A well adjusted implement enables a skilled operator to perform tasks quicker and better. When an implement has the desired features quickly available for use, the operator can significantly shorten the time needed to perform tasks.

The versatile implement built by the inventor, and disclosed herein, does a good job of meeting these needs. What is unexpected is how much work this lightweight implement can do. The chains positioned low on the working features provide great strength, while the pivot or rotational features receive much less force. It is the pivot or rotational features along with the vertical and gradient adjustment system that makes this implement so versatile for grading and working the soil.

### SUMMARY

The invention has several unique features. The implement has a vertical and gradient adjustment system and a claw assembly. Each of these features are unique.

The implement is lightweight; transportable on roads and highways; easily operated; simple in design; easily transformed from a working position to a transportable trailer with some stowed away features, and vice versa; the claw assembly can loosen hardened soil and bring some buried obstacles to the surface; the depth of the prongs can be adjusted; the prongs are stowable; the gradient of the implement can be changed; the torsion chain is a unique safety feature associated with the vertical and gradient adjustment system; and an axle and spring combination for strength, flexibility, and relatively safe gradient adjustment.

When the gradient adjustment system is incorporated into an implement, the height of each side, left and right, of the vertical and gradient adjustment system can be changed to change the gradient on the implement.

The claw assembly has one or more prongs that pivot on a support member that is transversely oriented with respect to implement movement, the support member can be attached to the frame or it can be part of the frame, and a chain for each prong connects the lower portion of the prong to a more forward part of the frame.

The gradient adjustment system has two separate and independently adjustable sides, right and left. With the exception of an optional torsion chain and an axle, the components on the right side of the gradient system are duplicated in a mirrored configuration on the left side of the gradient system, and vice versa.

The right side of the gradient system has a pivoting arm having a pivot portion and an end portion. The pivot portion has an axis feature. The axis feature occupies a transversely oriented aperture in the frame. The pivoting arm pivots on the axis feature along a vertical rotational path. A wheel is rotatably attached near the end portion of the pivoting arm. The wheel rotates on a transverse axis to the direction of displacement of the implement.

The right side of the gradient system has a power jack means pivotably attached on one end to the frame at a point away from the axis feature. The opposing end of the power jack means is pivotably attached to the end portion of the pivoting arm. The power jack means lengthens or shortens to change the angle of the pivoting arm in relation to the frame. This change in angle raises or lowers the right side of the frame.

The left side of the gradient system has a pivoting arm having a pivot portion and an end portion. The pivot portion has an axis feature. The axis feature occupies a transversely oriented aperture in the frame. The pivoting arm pivots on the axis feature along a vertical rotational path. A wheel is rotatably attached near the end portion of the pivoting arm. The wheel rotates on a transverse axis to the direction of displacement of the implement.

The left side of the gradient system has a power jack means pivotably attached on one end to the frame at a point away from the axis feature. The opposing end of the power jack means is pivotably attached to the end portion of the pivoting arm. The power jack means lengthens or shortens to change the angle of the pivoting arm in relation to the frame. This change in angle raises or lowers the left side of the frame.

The gradient system has an optional torsion chain. The torsion chain is attached to the end portion of the pivoting arm on the right side. The torsion chain is also attached to the end portion of the pivoting arm on the left side of the implement. The properly adjusted torsion chain is a safety feature that imposes a limit on the twisting of the implement when one side of the implement is higher than the other side of the implement.

The gradient system may have a transversely oriented axle that is attached to the end portion of the pivoting arm on the right side and is attached to the end portion of the pivoting arm on the left side. The gradient system may have springs connecting the pivoting arms, right and left, to the axle. The gradient system built by the applicant can achieve many inches of vertical difference from one side to the other side on a frame that is about five feet wide and the implement can still function under these conditions. This amount of gradient is unattainable on many other gradient systems while the system is engaged in a working situation.

The chains connected near the soil engaging features of the claw assembly make the claw assembly more durable than a person might normally expect. When the gradient adjustment system is incorporated into the same implement as the claw assembly, a change in the vertical and gradient adjustment system changes the gradient on the claw assembly. The torsion chain is a unique feature of the gradient adjustment system.

Shear pins, shear bolts, and shear links associated with the various chains and their points of attachment are optional. These shearing devices can be used to limit the force being applied to the working features of the implement. These devices can be used to avoid costly repairs and increase safety.

These and other features, aspects, and advantages of the present invention will become better understood with regard to the following description, appended claims, and accompanying drawings where:

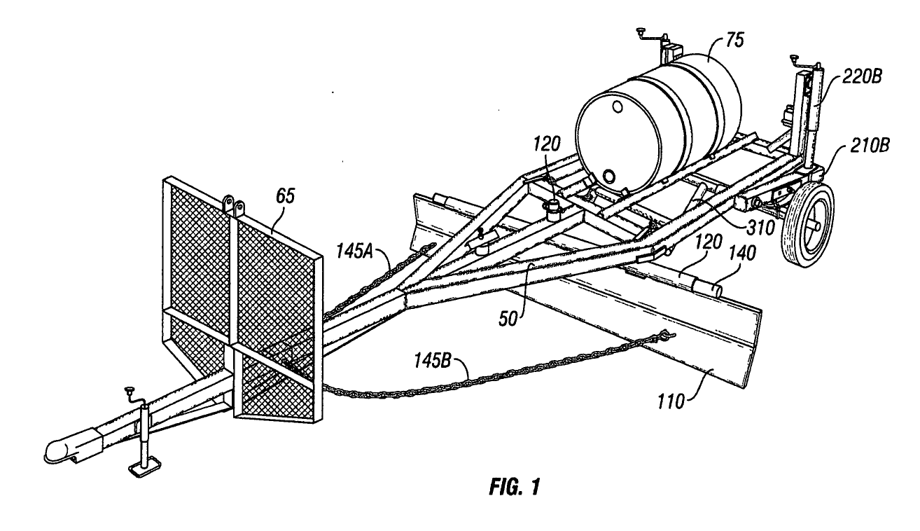

FIG. 1 shows an overall view of the implement, including the barrel and shield options,

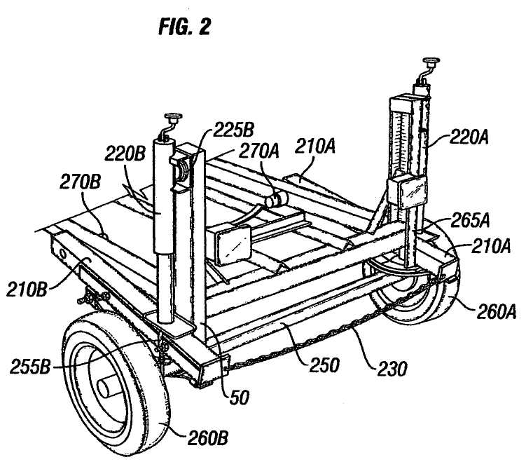

FIG. 2 shows an embodiment of the vertical and gradient adjustment system,

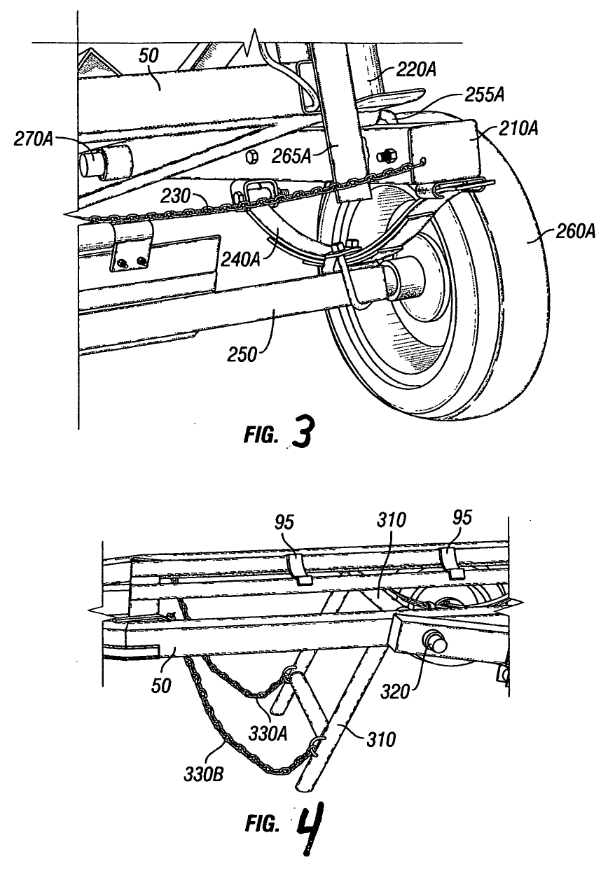

FIG. 3 shows a close up view of the axle and spring region of an embodiment of the vertical and gradient adjustment system, and

FIG. 4 shows a view of an embodiment of the claw assembly.

### DETAILED DESCRIPTION

In accordance with some embodiments described herein, an implement is disclosed having a vertical and gradient adjustment system (“gradient system” or “gradient adjustment system”) and an optional claw assembly. The vertical and gradient adjustment system is unique.

The invention does not require all the advantageous features and all of the advantages to be incorporated into every embodiment of the invention. The gradient system can be used with other implements unrelated to graders or soil maintenance.

For purposes of description, the “front” refers to the front of the implement. The “back” or “rear” refers to the back of the implement. “Forward” or “frontward” refers to a position toward the front of the implement. “Backwards” or “rearward” refers to a position toward the back of the implement. “Right” refers to the right side of the implement when the observer is facing in the same direction as the front of the implement is oriented. “Left” refers to the left side of the implement when the observer is facing in the same direction as the front of the implement is oriented.

“Transverse” refers to crosswise of forward. In most instances, “transverse” also means crosswise of forward and horizontal. “Frame” refers to any frame of an implement or supporting structure. A “member,” “support member,” or “support bar” is any supporting member whether a part of the frame or a supporting member attached to the frame.

A prong is a point, finger, plow, ripper, fork, braced fork, tine, or claw. A prong has an upper portion and a lower digging end. A braced fork is a fork having a plurality is of tines and a cross member joining two or more tines. A claw fork has two or more separated and parallel prongs, a sleeve attached to the prongs at a position on the prongs away from the lower end of the prongs, and a cross member attached near the lower end of the prongs. A prong chain is a chain that attaches to a prong.

A tongue is longitudinal member that usually attaches a frame or structure to a pulling vehicle. The tongue is usually at the front end of the implement. The gradient is the slope, inclination, or gradient. A shearing device could be a shear pin, spring loaded release, shear bolt, or a weaker chain link. A power jacks means can be screw types jacks, pneumatic cylinders, hydraulic cylinders, mechanical jacks, scissor jacks, and lever operated jacks. A latching means can be a clip, hook, slot for receiving links, vice, bolt, shackle, pin, or prong. A swiveling means can be a swivel, a bearing, or an axle. A means for pivotably attaching can be a hinge, a swivel, a bar inside a sleeve, a strong flexible fabric, a nylon band, a strap, a bearing, an axle, or a cable. A means for mounting can be a bearing, hub and bearing, an axle, or a swivel. A means for rotatably attaching can be a bearing, a bar inside a sleeve, an axle, hub and bearing, or a swivel.

The gradient of the implement is the slope of the frame when viewed from the rear of the implement. When the frame of the implement and the blade are made to be parallel with each other, the gradient of the implement and the gradient of the blade are nearly synonymous. The gradient of the implement and the gradient of the blade are adjusted by the same gradient adjustment system. In this description, the gradient of the implement and the gradient of the blade will be treated as synonymous, even though they may not be if frame of the implement and the blade are not made to be parallel with each other.

Applicant intends to encompass within the language any structure presently existing or developed in the future that performs the same function. In describing the components of the gradient system, the components on the right side of the implement will most likely be present in a mirrored configuration on the left side of the implement, and vice versa, unless otherwise described.

The claw assembly has a means for pivotably attaching that pivots on a transversely disposed support member, one or more prongs are attached to the means for pivotably attaching at a position on the prongs away from the lower portion of the prongs, and a chain for each prong connects the lower portion of the prong to said frame at a more forward part of said frame in relation to said prongs.

The support member is transversely disposed on the implement. The support member can be attached to the frame or it can be part of the frame. The means for pivotably attaching pivots on a transverse axis. The prongs have an upper portion and a lower digging portion. The prongs are suspended from the underside of the frame.

A claw fork has two or more separated and parallel prongs, a means for pivotably attaching is attached to the prongs at a position on the prongs away from the lower end of the prongs, and a cross member attached near the lower end of the prongs. The means for pivotably attaching can be a sleeve that pivots on a transversely disposed support member inside the sleeve.

The claw fork can replace some of the components of the claw assembly. For purposes of describing use, the prongs and claw fork may be used interchangeably, even though they are different.

The claw fork or prongs loosen compacted or hardened soil. When the prongs are in the desired working position, the claw chains provide force to hold the lower part of the prongs in position, while the means for pivotably attaching experiences much less force. The claw chains make the claw assembly strong and durable. This force is evident by how the prongs can dislodge some embedded objects, such as roots and rocks.

The claw assembly can break up hardened soil and dislodge some embedded rocks. The chain or the attachment site for the chain can be manufactured to break under certain tensions so that the prongs may raise the implement over the obstacle and pass by potentially dangerous obstacles. With the claw assembly lowered into the working position, the implement can usually be backed up without damaging the prongs.

The prongs can be stowed when not in use by pivoting the lower portion of the prongs forward and up and chaining the prongs to the frame. The prongs can be brought into a working position from the stowed position by unchaining the prongs from the frame, by pivoting the prongs downward and back, and reattaching the claw chain to the frame when the prongs are in the desired position.

The claw assembly has a trip feature. When the prongs encounter a large obstacle, the operator can reverse direction to pull the prongs away from the obstacle. In reverse, the prongs trips to pull out of the soil by pivoting the lower portion of the prongs forward. The claw chains generally do not interfere with the prongs when the claw assembly is tripping.

The trip feature allows the operator to back out of an obstacle, instead of having to adjust or raise the prongs to separate the claw fork from the obstacle. With the claw chains attached forward of the prongs, the operator can reset the prongs by pulling the implement forward a short distance and the prongs are restored to the working position without any adjustments to the implement. After reversing to separate the prongs from the obstacle, the operator can choose to engage the same obstacle again by pulling forward into the obstacle. By backing the implement, the operator may choose to engage the obstacle at a different location or in a different direction.

The length of the claw chains, the weight of the implement, and the height of the gradient system determine the penetration of the prongs provided the ground is not to hard to penetrate. The operator can adjust all three of these factors. The claw assembly is a much desired feature to be incorporated into a grader implement.

This implement can be made lightweight and strong. A lightweight implement using strong chains and the added weight of a barrel of water make this lightweight implement perform well for many tasks. When the task is completed, the barrel can be drained and the once heavy implement is lightweight again for transport on roads and highways.

It may be desirable to incorporate a shearing device into the chains or attachment points of the chains of the claw or blade assemblies. A shearing device could protect some of the features from damage should this implement encounter a large obstacle during use. If a shearing device is used, replacement shearing devices should be kept with the implement or designated pulling vehicle.

The gradient system is a system for raising, lowering, leveling, and adjusting the gradient of the implement. The gradient system has a set of components on each side, left and right, of the implement, an optional axle disposed transversely, and an optional torsion chain disposed transversely. The gradient system components on each side of the implement are pivoting arms, left and right, power jack means, left and right, wheels, left and right, optional springs, left and right, and optional frame guard extensions, left and right.

The height and gradient adjustment system on an implement comprises a frame, a first pivoting member, a first wheel, a first power jack means, a second pivoting member, a second wheel, an optional torsion chain, optional springs, an optional axle, and optional guard extensions.

The frame is usually disposed horizontally. The frame has a right side, a left side, a drawing end, and a rear end. The drawing end is the front end of the implement. The pivoting members are levers. The first pivoting member has a first end and a second end. The first end of the first pivoting member is pivotably attached to the right side of the frame. The first pivoting member pivots on a transverse axis and the first pivoting member pivots in a vertical plane. The first wheel is rotatably attached to the second end of the first pivoting member. The first wheel rotates on a transverse axis.

The first power jack means is an actuator. The first power jack means has a first end and a second end. The first end of the first power jack means is rotatably attached to the right side of the frame at a point away from the first end of the first pivoting member. The second end of the first power jack means is rotatably attached to the first pivoting member near the second end of the first pivoting member.

The second pivoting member has a first end and a second end. The first end of the second pivoting member is pivotably attached to the left side of the frame. The second pivoting member pivots on a transverse axis and the second pivoting member pivots in a vertical plane. The second wheel is rotatably attached to the second end of the second pivoting member. The second wheel rotates on a transverse axis.

The second power jack means Is an actuator. The second power jack means has a first end and a second end. The first end of the second power jack means is rotatably attached to the left side of the frame at a point away from the first end of the second pivoting member. The second end of the second power jack means is rotatably attached to the second pivoting member near the second end of the second pivoting member. The terms “pivoting arm” and “pivoting member” are used synonymously.

The torsion chain is a chain having a first end and a second end. The first end of the torsion chain is attached to the second end of the right pivoting member. The second end of the torsion chain is attached to the second end of the left pivoting member. The torsion chain when adjusted properly prevents excess torsion from being applied to the implement when the right and left sides of the implement are at different heights due to unequal extensions of the first and second power jack means.

The optional springs include a first spring and a second spring. The first spring links the second end of the right pivoting member to the first wheel. The first spring is attached to the second end of the right pivoting member. The first wheel is rotatably attached to the first spring. The second spring links the second end of the left pivoting member to the second wheel. The second spring is attached to the second end of the left pivoting member. The second wheel is rotatably attached to the second spring. The attachment of the wheels to the springs may be an indirect attachment.

Leaf springs are the preferred springs for the gradient adjustment system. The optional axle is a preferred way to indirectly attach the wheels to the springs. The axle has a left end and a right end. The axle is disposed transversely. The first wheel is rotatably attached to the right end of the axle and the second wheel is rotatably attached to the left end of the axle. The first spring links the right end of the axle to the second end of the right pivoting member. The second spring links the left end of the axle to the second end of the left pivoting member.

The guard extensions are structural elements that provide resistance to prevent the second ends of the pivoting members from moving laterally inward. The first guard extension is attached to the rear end of the right side of the frame. The first guard extension extends downward from the rear end of the frame to nearly abut the inside surface of the second end of the first pivoting member. The first guard extension almost abuts the first pivoting member along the entire path of the first pivoting member while allowing the first pivoting member to move unimpeded.

The second guard extension is attached to the rear end of the left side of the frame. The second guard extension extends downward from the rear end of the frame to nearly abut the inside surface of the second end of the second pivoting member. The second guard extension almost abuts the first pivoting member along the entire path of the first pivoting member while allowing the first pivoting member to move unimpeded. The terms “guard extension” and “frame guard extension” are used synonymously.

When the power jacks means are lengthened, the angle between the pivoting arms and the frame changes and the entire frame elevates. When the power jacks means are shortened, the angle between the pivoting arms and the frame changes and the entire frame lowers. When the power jack means on one side is lengthened, the frame on that side rises. When the power jack means on one side is shortened, the frame on that side lowers.

When both sides of the implement are the same height, the frame is undistorted. When the sides of the implement have different heights, there is a twisting force being applied to the implement. It is desirable to have a feature in the implement that will nondestructively bend or absorb the differences, between the two sides of the implement. The applicant used leaf springs and an axle to alleviate some of the twisting force.

As an operator is adjusting the gradient system to raise one side of the implement higher than the other side or lower one side of the implement lower than the other side, the operator may notice that the structure of the gradient system will offer increased resistance to the distortion being applied, even without the torsion chain being attached.

The lowering of the frame lowers the blade and prongs to enable engagement or deeper penetration of the soil. The raising of the frame raises the blade and prongs to allow disengagement or less penetration of the soil. The frame is raised during is transport and lowered during use.

The gradient system enables the transverse slope of the implement to be modified. The gradient system can be incorporated into other applications and implements. The gradient system is a desirable feature to be incorporated into a grading implement. When the gradient system is incorporated into an implement having the disclosed blade assembly, it enables the operator to adjust the gradient of the blade for the particular application.

The gradient system is easy to adjust. The height of each side can be independently adjusted for the particular application. When modifying the gradient, the operator will most likely want to readjust the length of the torsion chain. During normal operations having little or no twisting force on the implement, the torsion chain is properly adjusted when there is about a three inch downward deflection of the middle of the torsion chain for every 52 inches of torsion chain length. Before and after adjusting the gradient, the operator should examine the tension being applied to the torsion chain.

When the length of the torsion chain between the two pivoting arms is properly adjusted, the torsion chain will tighten to relieve some of the twisting force that can occur occasionally. The torsion chain, when properly adjusted, can prevent one side of the gradient system from being overextended relative to the other side. The applicant used an approximately 730 lbs. working load chain for the torsion chain.

The optional frame guard extensions are guards that are attached to the frame. The frame guard extensions almost abut the pivoting arms, but are not attached to the pivoting arms. The frame guard extensions prevent the pivoting arms from bending laterally into the frame during rigorous use or accidental incidents.

The torsion chain can be an impediment to the gradient adjustment. When the two sides of the implement have different heights, a twisting force is created. The torsion chain is an optional safety feature for limiting the amount of twisting force being applied to the frame and implement.

The optional torsion chain that complements the vertical and gradient adjustment system, is an adjustable safety feature that keeps the implement from twisting past a point designated by the operator's adjustment of the torsion chain. Should the implement be operated in areas of deep ravines and holes, the torsion chain may keep one side of the implement from falling to far into the ravine or hole.

As more twist is being applied to the frame and implement, the torsion chain will tighten. When the torsion chain tightens, the operator should consider the prudence of whether to apply that amount of twist to the frame and whether to lengthen the torsion chain. The torsion chain is especially desirable for limiting the twist on the frame when one side of the implement falls or rolls into a hole or crevice or one side encounters an extreme height displacement during operation.

While the torsion chain can limit the twisting force and the excessive application of slope to the frame, some twisting force will be applied to one or more parts of the implement. The springs are a likely site for alleviating some of twisting force. If a part on one side, left or right, were to break during transport or use, a properly adjusted torsion chain may prevent consequential damage to the implement or to the road.

Because an axle is a strong structural feature for implements, the applicant likes the leaf spring and axle combination in the gradient system. While other types of springs and wheel supporting structures, like an independent suspension design, may be used and may be workable, the applicant prefers the axle and leaf spring combination to other competing combinations for the gradient system.

A preferred embodiment of the invention is an axle attached to the pivoting arms by leaf springs. In the preferred embodiment, the leaf springs are the only attachment between the axle and pivoting arms. A preferred embodiment of the invention is depicted in the drawings, as this is substantially similar to the implement the applicant built for his own personal use.

In FIG. 1, the implement is built like a light trailer. The implement has a long tongue, not labeled, to attach a frame 50 of the implement to a pulling vehicle, a shield 65, a blade assembly 100, not labeled, a claw assembly 300, not labeled, a barrel 75, and a vertical and gradient adjustment system 200, not labeled.

The description of FIG. 1 is presented to describe those elements that can be easily viewed in FIG. 1. The gradient system 200 and claw assembly 300 are partially hidden and are difficult to see in FIG. 1. These features will be described in more detail with other figures.

The frame 50 consists of two longitudinal support members, two cross members attached to the longitudinal support members, and two vertical members (“upright members”), with each vertical member being attached to one longitudinal support member.

The shield 65 is a large planar structure that is attached to the middle of the tongue of the implement. The shield 65 is shown in the upright (working) position in FIG. 1. On the tongue and just behind the shield is a latching mechanism 147, partially hidden and not labeled in FIG. 1, but is labeled in FIG. 2. The latching mechanism receives the blade chains (145A right and 145B left, collectively 145) from the blade 110.

The latching mechanism 147 is attached to the tongue of the implement at a position forward of the blade 110. The latching mechanism has a latching means on each side, left and right, of the tongue. The latching means is a slot in the latching mechanism 147 for receiving the chain links of the blade chains 145. The latching mechanism holds the blade chains at a particular length.

The frame 50 has a vertical hole, not labeled, extending through the frame. A swiveling rotational sleeve 120 has an upper swiveling portion and a lower sleeve portion. The upper swiveling portion, rotating on a nearly vertical axis, of the swiveling rotational sleeve occupies the vertical hole in the frame. The lower sleeve portion has a horizontally oriented aperture through the entire length of the sleeve. The lower sleeve portion rotates on a nearly horizontal path. The lower sleeve portion of the swiveling rotational sleeve is suspended from the underside of the frame. The swiveling rotational sleeve 120 rotates around a vertical axis.

Inside the sleeve portion of the swiveling rotational sleeve 120 is a rotational bar 140. The rotational bar 140 extends out both ends of the swiveling rotational sleeve 120. The opposing ends of the rotational bar 140 are attached to a blade 110. The blade 110 and rotational bar 140 pivot on a horizontal axis in relation to the swiveling portion of the swiveling rotational sleeve 120, which rotates on a vertical axis.

The blade 110 is held into the different physical orientations by blade chains 145. The blade chain 145A attaches to the lower portion of the blade at a point right of center of the blade. The blade chain 145B attaches to the lower portion of the blade at a point left of center of the blade. The opposing ends of the blade chains 145A and 145B are received by the latching mechanism 147, partially hidden and not labeled.

In FIG. 2, the rear end of the implement is depicted. This view shows the gradient system 200, not labeled. The gradient system 200 has two pivoting arms (210A and 210B, collectively 210), two power jack means (220A and 220B, collectively 220), two rotational pins (255A, not visible, and 255B, collectively 255), two jack swivels (225A, not visible, and 225B, collectively 225), two leaf springs, partially hidden and not labeled, axle 250, two wheels (260A and 260B, collectively 260), and a torsion chain 230.

The frame 50 has two transverse apertures, not labeled, one aperture in a right side longitudinal member of the frame and the other aperture in a left side longitudinal member of the frame. The pivoting arms 210 have a transversely oriented axis feature 270 on each pivoting arm. The axis features are labeled 270A and 270B. The axis feature 270A of the pivoting arm 210A occupies the transverse aperture on the right side of the frame.

The axis feature 270B of the pivoting arm 210B occupies this transverse aperture on the left side of the frame. The axis features 270 have a transversely oriented aperture, not labeled, through the axis feature. When the claw assembly 300, not shown, is attached to the implement, the axis bar 320, not shown, occupies the axis features 270 of the pivoting arms 210. The pivoting arms pivot on a transverse axis and have a nearly vertical path of pivoting.

The leaf springs 240 are longitudinally attached to the underside of the pivoting arms 210 near the end portion of the pivoting arms at both ends of the leaf spring. The middle portion of the leaf springs is attached to a transversely disposed axle 250.

The axle has wheels 260 on both ends of the axle. The wheels 260 have a transverse axis of rotation. On the lower ends of the power jack means 220 are rotational pins 255 that pivotably attach the power jack means to the pivoting arms 210. The power jack means 220 are vertically oriented. The upper end of the power jack means are pivotably attached to an upright member, not labeled, of the frame by jack swivels 225.

The frame guard extensions 265 are downward extensions from the upright members of the frame 50. The frame guard extensions 265 are attached to the frame 50, but not to the pivoting arms 210. The frame guard extensions 265 almost abut the pivoting arms 210 along the opertational orientations of the pivoting arms.

The optional torsion chain 230 connects the end portion of the pivoting arm 210A to the end portion of the pivoting arm 210B. The torsion chain is a desirable safety feature.

In FIG. 3, the lower rear portion of the right side of the gradient system 200, not labeled, is illustrated. The frame 50 has a transverse aperture, not labeled, in a right side longitudinal member of the frame. The axis feature 270A of the pivoting arm 210A occupies this transverse aperture in the frame. The axis feature 270A has an aperture, not labeled, through it.

The pivoting arm 210A is pivotably attached to the frame 50 via the axis feature 270A occupying the aperture in the frame. The pivoting arm pivots on a transverse axis along a nearly vertical path. The leaf spring 240A is longitudinally attached near the rear end portion of the pivoting arm 210A at both ends of the leaf spring. The middle portion of the leaf spring is attached to a transversely disposed axle 250.

The axle has wheels (260A, shown and labeled, and 260B, not shown) on both ends of the axle. Above the axle on the pivoting arm 210A is a rotational pin 255A that pivotably attaches the pivoting arm to the lower end of the power jack means 220A. The power jack means 220A is vertically oriented. The upper end, not shown, of the power jack means is pivotably attached to an upright member of the frame, partially shown and not labeled. The frame guard extension 265A is a downward extension from the upright member of the frame.

The frame guard extension 265A is attached to the frame, but not to the pivoting arms 210. The frame guard extension 265A almost abuts the pivoting arm 210A along the operational orientations of the pivoting arms. Most of the previously described components In relation to FIG. 3, looking at the right side of the implement, are duplicated in a mirrored configuration on the left side of the implement.

The optional torsion chain 230 connects the end portion of the pivoting arm 210A to the end portion of the pivoting arm 210B. The torsion chain is a desirable safety feature.

In FIG. 4, the claw assembly 300, not labeled, is illustrated. In this embodiment, the claw assembly has a claw fork 310, an axis bar 320, and claw chains (330A and 330B). The claw fork 310 consists of two prongs, not labeled, a rotational sleeve, not labeled, and a cross bar, not labeled, joining the two prongs.

The claw fork 310 pivots on a transverse axis. The two prongs, not labeled, are the parallel members that have a vertical rotational path. The rotational sleeve of the claw fork is disposed transverse to the implement between two longitudinal members of the frame. The rotational sleeve of the claw fork is the sleeve that surrounds the middle portion of the axis bar 320. The cross bar of the claw fork is the transverse member that joins the two prongs together near the lower digging ends of the prongs.

The axis bar 320 is a support member that is disposed transverse to the implement. The axis bar occupies two apertures, not labeled, in the longitudinal members of the frame. One end of the axis bar 320 occupies an aperture in a right side longitudinal member of the frame and the opposing end of the axis bar occupies an aperture in a left side longitudinal member of the frame. When the optional claw assembly 300 is attached to the implement, the axis bar 320 occupies the axis feature 270A of the pivoting arm 210A and the axis bar 320 also occupies the axis feature 270B on the pivoting arm 210B.

The prong chains 330 attach near the ground engaging ends of the claw fork 310 with prong chain 330A attaching to the prong on the right side of the claw fork and prong chain 330B attaching to the prong on the left side of the claw fork. The prong chain 330A attaches to the frame at a more forward part of said frame in relation to said prongs. The prong chain 330B attaches to the frame at a more forward part of said frame in relation to said prongs.

The rotational sleeve of the claw fork 310 pivots on the axis bar 320. The rotational sleeve enables the claw fork 310 to pivot upward into a non-working position or pivot downward into a working position. The claw fork 310 is supported the axis bar 320.

While the invention has been described with respect to a limited number of embodiments, those skilled in the art may appreciate numerous modifications and variations therefrom. It is intended that the appended claims cover all such modifications and variations as fall within the true spirit and scope of the invention.

1-20. (canceled)

21. An implement for grading soil and soil components, the implement comprising:
a frame, wherein the frame has a drawing end and a rear end, wherein the frame has a topside and an underside, wherein the frame has one or more longitudinal members and one or more cross members, wherein the cross members of the frame are attached to the longitudinal members of the frame,
a single pair of wheels rotatable about an axis extending transversely of the frame with respect to the direction of displacement of the implement, wherein the wheels are rotatably attached to the frame,
a swiveling means attached to the frame, wherein the swiveling means has a vertical axis of rotation, wherein the swiveling means has a topside and an underside,
a blade having a upper portion and lower portion, wherein the upper portion of the blade is attached to the underside of the swiveling means, wherein the upper portion of the blade is suspended horizontally underneath the swiveling means, wherein the blade has a vertical axis of rotation and the blade pivots on a horizontal axis,
a first chain having a first end and a second end, wherein the first end of the first chain is attached to the lower portion of the blade at a point to the right of the center of the blade, wherein the second end of the first chain is attached to the frame at a point closer to the drawing end of the frame than the blade, and
a second chain having a first end and a second end, wherein the first end of the second chain is attached to the lower portion of the blade at a point to the left of the center of the blade, wherein the second end of the second chain is attached to the frame at a point closer to the drawing end of the frame than the blade.

22. The implement of claim 21, wherein the first end of the first chain is revocably attached to the blade and the first end of the second chain is revocably attached to the blade.

23. The implement of claim 22, further comprising:
a third chain having a first end and a second end, wherein the first end of the third chain is revocably attached to the lower portion of the blade at a point to the right of the center of the blade, wherein the third chain is revocably attached to the frame at a point above the point of attachment of the first end of the third chain to the blade, wherein the first end of the first chain is revocably attached to the third chain near the point of attachment of the third chain to the blade, and
a fourth chain having a first end and a second end, wherein the first end of the fourth chain is revocably attached to the lower portion of the blade at a point to the right of the center of the blade, wherein the fourth chain is revocably attached to the frame at a point above the point of attachment of the first end of the fourth chain to the blade, wherein the first end of the second chain is revocably attached to the fourth chain near the point of attachment of the fourth chain to the blade, whereby this different arrangement of the chains increases the distance between the bottom edge of the lower portion of the blade and the points of attachment of the first ends of the first and second chains.

24. The implement of claim 21, wherein the second end of the first chain is revocably attached to the frame at a point closer to the drawing end of the frame than the blade and the second chain is revocably attached to the frame at a point closer to the drawing end of the frame than the blade.

25. The implement of claim 23, wherein the second end of the first chain is revocably attached to the frame at a point closer to the drawing end of the frame than the blade and the second chain is revocably attached to the frame at a point closer to the drawing end of the frame than the blade.

26. The implement of claim 21, further comprising:
one or more prongs having a top end and a lower digging end, wherein the prongs are pivotably attached to the frame and the prongs pivot on a horizontal axis, wherein the lower digging end of the prongs can pivot into a position lower than the frame, and
one or more prong chains having first ends and second ends, wherein the first ends of the prong chains are attached near the digging end of the prongs, wherein the second ends of the prong chains are attached to the frame at a point closer to the drawing end of the frame than the prongs.

27. The implement of claim 26, further comprising:
a transverse member, wherein the transverse member is attached to a plurality of the prongs at points near the lower digging end of the prongs.

28. The implement of claim 26, wherein the first ends of the prong chains are revocably attached near the digging end of the prongs.

29. The implement of claim 26, wherein the second ends of the prong chains are revocably attached to the frame at a point closer to the drawing end of the frame than the prongs.

30. The implement of claim 21, further comprising:
a first pivoting member having a first end and a second end, wherein the frame has a right side and a left side, wherein the first end of the first pivoting member is pivotably attached to the right side of the frame, wherein the first pivoting member pivots on a transverse axis to the direction of displacement of the implement and the first pivoting member pivots in a vertical plane, wherein the wheels comprise a first wheel and a second wheel, wherein the first wheel is rotatably attached to the first pivoting member near the second end of the first pivoting member and the first wheel rotates on a transverse axis to the direction of displacement of the implement, wherein the second wheel is rotatably attached to the second pivoting member near the second end of the first pivoting member and the second wheel rotates on a transverse axis to the direction of displacement of the implement
a first power jack means having a first end and a second end, wherein the first end of the first power jack means is pivotably attached to the right side of the frame at a point away from the attachment point of the first end of the first pivoting member and the second end of the first power jack means is pivotably attached to the first pivoting member at a point away from the first end of the first pivoting member,
a second pivoting member having a first end and a second end, wherein the first end of the second pivoting member is pivotably attached to the left side of the frame, wherein the second pivoting member pivots on a transverse axis to the direction of displacement of the implement and the second pivoting member pivots in a vertical plane,
one or more second wheels, wherein the second wheels are rotatably attached near the second end of the second pivoting member and the second wheels rotate on a transverse axis to the direction of displacement of the implement, and
a second power jack means having a first end and a second end, wherein the first end of the second power jack means is pivotably attached to the left side of the frame at a point away from the attachment point of the first end of the second pivoting member and the second end of the second power jack means is pivotably attached to the second pivoting member at a point away from the first end of the second pivoting member,
wherein the height of each side, right or left, of the frame is independently adjustable from the other side of the frame, whereby substantial differences in gradient from the left side to the right side can be attained and can be maintained while the implement is being used in a working situation.

31. The implement of claim 30, further comprising:
a torsion chain having a first end and a second end, wherein the first end of the torsion chain is attached near the second end of the first pivoting member and the second end of the torsion chain is attached near the second end of the second pivoting member, whereby the torsion chain functions as a safety feature to prevent excessive implement torsion when one side of the frame is elevated relative to the other side of the frame.

32. The implement of claim 31, wherein the first end of the torsion chain is revocably attached near the second end of the first pivoting member.

33. The implement of claim 30, further comprising:
a first spring, wherein the first spring is attached to the first pivoting member at a point away from the first end of the first pivoting member and the first wheels are rotatably attached to the first spring, whereas the first spring is a linking element between the first pivoting member and the first wheels, and
a second spring, wherein the second spring is attached to the second pivoting member at a point away from the first end of the second pivoting member and the second wheels are rotatably attached to the second spring, whereas the second spring is a linking element between the second pivoting member and the second wheels.

34. The implement of claim 33, further comprising:
a torsion chain having a first end and a second end, wherein the first end of the torsion chain is attached near the second end of the first pivoting member and the second end of the torsion chain is attached near the second end of the second pivoting member, whereby the torsion chain functions as a safety feature to prevent excessive implement torsion when one side of the frame is elevated relative to the other side of the frame.

35. The implement of claim 34, wherein the first end of the torsion chain is revocably attached near the second end of the first pivoting member, whereby the torsion chain functions as a safety feature to prevent excessive implement torsion when one side of the frame is elevated relative to the other side of the frame.
The implement of claim 30, further comprising:
a first set of leaf springs attached to the first pivoting member,
a second set of leaf springs attached to the second pivoting member, and
an axle, the first set of leaf springs is attached near the right end of the axle and the second set of leaf springs is attached near the left end of the axle, wherein the first wheels are rotatably attached to the right side of the axle and the second wheels are rotatably attached to the left side of the axle.

37. The implement of claim 36, further comprising:
a torsion chain having a first end and a second end, wherein the first end of the torsion chain is attached near the second end of the first pivoting member and the second end of the torsion chain is attached near the second end of the second pivoting member, whereby the torsion chain functions as a safety feature to prevent excessive implement torsion when one side of the frame is elevated relative to the other side of the frame.

38. The implement of claim 37, wherein the torsion chain is revocably attached to one or more of the pivoting members.
